(19) United States
(12) Patent Application Publication
(10) Pub. No.: US 2025/0212909 A1
(43) Pub. Date: Jul. 3, 2025

(54) A PROCESS FOR THE PREPARATION OF FAT-BASED CONFECTION COMPOSITIONS

(71) Applicant: Conopco, Inc., d/b/a UNILEVER, Englewood Cliffs, NJ (US)

(72) Inventors: William James FRITH, Leighton Buzzard (GB); Nicholas David HEDGES, Towcester (GB); Chujiao LIU, Dunstable (GB)

(73) Assignee: Conopco, Inc., d/b/a UNILEVER, Englewood Cliffs, NJ (US)

(21) Appl. No.: 18/851,858

(22) PCT Filed: Mar. 22, 2023
(86) PCT No.: PCT/EP2023/057275

§ 371 Date: Sep. 27, 2024

(30) Foreign Application Priority Data
Mar. 31, 2022 (EP) 22166167.1

(51) Int. Cl. A23G 9/32; A21D 2/02; A21D 2/16; A21D 2/18; A21D 13/28; A23G 9/34

(52) U.S. Cl. CPC A23G 9/325; A21D 2/02; A21D 2/165; A21D 2/181; A21D 13/28; A23G 9/322; A23G 9/327; A23G 9/34

(57) ABSTRACT

A process for the preparation of fat-based confection compositions comprising calcium carbonate and sugars, the process comprising the steps of mixing and heating a composition comprising: non-fat solid particles, fat and emulsifier to form a dispersion, wherein the non-fat solid particles comprise sugars and calcium carbonate; and refining the particles of the dispersion to have a Dᵥ₉₀ of less than 50 microns.

### FIELD OF THE INVENTION

A process for the preparation of fat-based confection compositions comprising calcium carbonate and sugars, fat-based confection compositions obtainable from the process, the use of the fat-based confection compositions and products prepared therefrom.

### BACKGROUND OF THE INVENTION

Confection products may comprise one or more fat-based confection composition(s). Such fat-based confection compositions include, for example, chocolate or chocolate analogues. These fat-based confection compositions may be present in confection products in the form of coatings, toppings, sauces or inclusions. The formulation, size distribution of the particles, and temperature of the fat-based confection composition affect the physical properties of the composition, e.g. the rheology. The rheology of a fat-based confection composition determines the physical characteristics of the composition during processing, and as a component of a confection product. For example, a composition that is very viscous would result in a thick coating of the fat-based composition when applied to, for example, frozen confection (The Science of Ice Cream: C. Clarke; RSC 2012, Ch 5).

A typical process for the preparation of chocolate or chocolate analogue compositions includes the steps of: mixing, heating and optionally kneading the composition ingredients at 40° C. or greater; followed by refining and optionally conching the composition, and then optionally fluidizing and optionally cooling the fluidized composition. Method steps and apparatus are described in Chapter 2 (Chocolate Manufacture, S. Beckett) of Science and Technology of Enrobed and Filled Chocolate, Confectionery and Bakery Products (2009, ISBN: 978-1-84569-390-9) and in Chapter 9 (Cocoa bean processing and the manufacture of chocolate) of The International Cocoa Trade by Robin Dand (2011, ISBN: 978-0-85709-125-3).

The rheology of a fat-based confection composition is also affected by the presence of water in the composition. The addition of water to fat-based confection compositions such as chocolate or chocolate analogue compositions is typically avoided because water can hydrate the sugar particles. Hydration of the sugar particles strengthens the interactions between them and dramatically increases the viscosity of the composition (The Science of Ice Cream: C. Clarke; RSC 2012, Ch 5).

When water is present in a fat-based confection composition, it is typically introduced through residual amounts of water present in both milk solids and hygroscopic sugars. Additionally, if the fat-based confection composition is used, for example, for coating a frozen confection by use of a dipping tank, water is transferred from the frozen confection material that is being dipped. Consequently, the use of sugars or other ingredients that are highly hygroscopic in fat-based confection compositions is typically avoided. Furthermore, a fat-based composition for use in processes such as those requiring non-anhydrous conditions, or the coating of frozen confection by dipping, has a limited duration of use because the amount of water present in the fat-based confection composition increases over time with use and results in a viscosity that is too high to achieve the required coating thickness. The water-containing fat-based confection composition is then discarded as a waste product.

There is a need for fat-based compositions to have a greater resilience to the rheological effect caused by the presence of water in the composition. Such an increased resilience would enable existing fat-based compositions to tolerate a greater amount of water in, for example, processes that require the composition to come into contact with a source of water, such as coating a confection by dipping, or non-anhydrous process conditions. The increased resilience of the fat-based confection composition to water would result in fat-based confection compositions having a longer shelf-life and consequently reducing waste.

Furthermore, a fat-based confection composition that has an increased resilience to the presence of water would enable a greater variety of non-fat solid particles to be present in the fat-based confection composition. For example, sugars such as sucrose that are less hygroscopic could be substituted with sugars that are more hygroscopic, such as fructose. If a sugar that is more hygroscopic and which has a high sweetness perception, e.g. fructose, is substituted for a sugar that is less hygroscopic with a lower sweetness perception, e.g. sucrose, it would be possible to prepare a fat-based confection composition comprising a reduced sugar content but with the same or similar level of sweetness. This would enable a reduction of sugar present in the fat-based confection composition and consequently a reduction in calories without affecting the physical characteristics of the composition.

### SUMMARY OF THE INVENTION

It has now been discovered that fat-based confection compositions prepared by a process comprising steps (a) to (h), below, result in compositions that have a greater resilience to the rheological effect caused by the presence of water in the composition compared to fat-based confection compositions prepared according to known processes, such as those disclosed in Chapter 2 (Chocolate Manufacture, S. Beckett) of Science and Technology of Enrobed and Filled Chocolate, Confectionery and Bakery Products (2009, ISBN: 978-1-84569-390-9) and in Chapter 9 (Cocoa bean processing and the manufacture of chocolate) of The International Cocoa Trade by Robin Dand (2011, ISBN: 978-0-85709-125-3).

It is thought that the addition of calcium carbonate to the process for the preparation of the fat-based confection composition enables the reduction of the sugar-water interaction and therefore increases the resilience of the fat-based confection composition to the effect on the rheology of the composition by water.

More specifically, the present invention relates to a process for the preparation of a fat-based confection composition comprising the steps of:
(a) mixing and heating a composition comprising: non-fat solid particles, fat and emulsifier to form a dispersion, wherein the non-fat solid particles comprise sugars and calcium carbonate;
(b) optionally admixing additional non-fat solid particles;
(c) optionally kneading the composition of step (a) or (b);
(d) refining the particles of the dispersion of step (a), (b), or (c), wherein the particles of the dispersion have a Dᵥ₉₀ of less than 50 microns;
(e) optionally admixing additional fat and emulsifier to the dispersion of step (d);
(f) optionally conching the dispersion of step (d) or (e);
(g) optionally fluidizing the product of step (d), (e), or (f); and,
(h) optionally cooling to less than 10° C.

The present invention also relates to a fat-based confection composition obtainable by the process, wherein the sugars comprise fructose, the use of the fat-based confection compositions for coating confections products, and coated confection products comprising the fat-based confection compositions.

### DETAILED DESCRIPTION OF THE INVENTION

A process for the preparation of a fat-based confection composition comprising the steps of:
(a) mixing and heating a composition comprising fat, non-fat solid particles and emulsifier to form a dispersion, wherein the non-fat solid particles comprise sugars and calcium carbonate;
(b) optionally admixing additional non-fat solid particles to the dispersion of step (a),
(c) optionally kneading the dispersion of step (a) or (b);
(d) refining the particles of the dispersion of step (a), (b), or (c), to achieve a dispersion wherein the particles of the dispersion have a Dᵥ₉₀ of less than 50 microns;
(e) optionally admixing additional fat and emulsifier to the dispersion of step (d);
(f) optionally conching the dispersion of step (d) or (e);
(g) optionally fluidizing the product of step (d), (e), or (f);
(h) optionally cooling to less than 10° C.

In an embodiment of the invention the non-fat solid particles of step (a) are selected from the group consisting of sugars, calcium carbonate, particles originating from cocoa solids, non-fat milk solids, bulking agents, and mixtures thereof.

In a further embodiment of the invention the non-fat solid particles of step (a) are selected from the group consisting of sugars and calcium carbonate, and the additional non-fat solid particles of step (b) are selected from the group consisting of sugars, calcium carbonate, particles originating from cocoa solids, non-fat milk solids, bulking agents, and mixtures thereof.

In an embodiment of the invention step (a) is heated to a temperature of greater than 40° C., preferably from 40° C. to 80° C., from 42° C. to 70° C., or even from 45° C. to 60° C.

In an embodiment of the invention the dispersion of step (f) is heated to from 45° C. to 90° C., preferably from 45° C. to 80° C., or even from 45° C. to 70° C.

In an embodiment of the invention the particles of the dispersion of steps (a), (b), or (c) are refined in step (d) to achieve a dispersion wherein the particles of the dispersion have a Dᵥ₉₀ of less than 50 microns, preferably wherein the particles of the dispersion have a Dᵥ₉₀ of less than 40 microns, wherein the particles of the dispersion have a Dᵥ₉₀ of less than 35 microns, or even wherein the particles of the dispersion have a Dᵥ₉₀ of less than 30 microns.

Volume median particle size, Dᵥ₉₀ value, measured using a Malvern Mastersizer 2000 Laser Diffraction System, indicates a diameter value such that 90% by volume of the particles have a diameter of less than this value. A method for measuring Dᵥ₉₀ is described in EP 3 250 042 A1. Mixing and heating may be carried out in apparatus such as a ball mill. Admixing means the addition of ingredients into a dispersion. Kneading means working into a paste, for example using a kneading arm. Refining means grinding the dispersion in for example, a roll refiner. Conching means stirring and mixing, optionally with heating. Fluidizing means the addition of fat to the dispersion in order to adjust the fat content of the fat-based confection composition to achieve the desired rheology of the fat-based confection composition. Method steps and apparatus are described in Chapter 2 (Chocolate Manufacture, S. Beckett) of Science and Technology of Enrobed and Filled Chocolate, Confectionery and Bakery Products (2009, ISBN: 978-1-84569-390-9) and in Chapter 9 (Cocoa bean processing and the manufacture of chocolate) of The International Cocoa Trade by Robin Dand (2011, ISBN: 978-0-85709-125-3).

The invention further relates to a fat-based confection composition obtainable by the process for the preparation of a fat-based confection composition, wherein the fat-based confection composition comprises from 1 wt % to 40 wt % calcium carbonate and from 20 wt % to 45 wt % sugars, wherein the sugars comprises fructose, and wherein the particles of the composition have a Dᵥ₉₀ of less than 50 microns, and wherein step (a) of the process comprises mixing and heating a composition comprising: non-fat solid particles, fat and emulsifier to form a dispersion, wherein the non-fat solid particles comprise fructose and calcium carbonate.

Fat-based confection composition means a confectionery composition comprising non-fat solid particles dispersed in a continuous fat phase. The non-fat solid particles are dispersed homogenously in the continuous fat phase. Continuous fat phase means a composition comprising triglycerides. The continuous fat phase (fat content) is a composition comprising a blend of one or more fats, one or more oils, or one or more fats and one or more oils. Fats and oils may be obtained from natural sources such as plant, seed and dairy products, or fractions thereof, or prepared synthetically.

Exemplary fats and oils include: palm oil, palm oil fractions such as palm stearin, palm kernel oil, cocoa butter, cocoa butter replacer, cocoa butter equivalent, coconut oil, high oleic liquid oils, sunflower oil, safflower oil, canola oil, corn oil, olive oil, cottonseed oil, flax seed oil, almond oil, soybean oil, grapeseed oil, rice bran oil, hemp seed oil, sesame oil, peanut oil, butter oil, and mixtures thereof. US 2017/0318831 describes cocoa butter and cocoa butter substitutes, equivalent and replacer are interchangeable terms and mean cocoa butter interchangeable fats such as illipe butter, Borneo tallow and Shea butter.

High oleic liquid oils include: high oleic sunflower oil, high oleic soy bean oil, high oleic safflower oil and high oleic canola oil. The term canola oil is synonymous with rapeseed oil.

In an embodiment of the invention, fat is selected from the group consisting of palm oil, palm oil fractions, cocoa butter, cocoa butter replacer, cocoa butter equivalent, coconut oil, high oleic liquid oils, sunflower oil, safflower oil, canola oil, corn oil, olive oil, and mixtures thereof.

In an embodiment of the invention the fat is selected from the group consisting of palm oil, palm oil fractions, cocoa butter, coconut oil, high oleic liquid oils, sunflower oil, canola oil, safflower oil, olive oil, and mixtures thereof. In a preferred embodiment of the invention the fat is a blend of fats selected from the group consisting of palm oil, palm oil fractions, cocoa butter, coconut oil, high oleic liquid oils, sunflower oil, olive oil, and mixtures thereof. Preferably, the fat is a blend of fats selected from the group consisting of cocoa butter, coconut oil, high oleic sunflower oil, high oleic safflower oil, high oleic canola oil, sunflower oil, and olive oil.

The fat-based confection composition preferably comprises from 35 wt % to 65 wt % fat, from 40 wt % to 65 wt % fat, from 45 wt % to 65 wt % fat, more preferably from 48 wt % to 55 wt % fat.

Fats and oils comprise triglycerides that comprise saturated or unsaturated fatty acid chains. Triglycerides may be monounsaturated (MUFA), polyunsaturated (PUFA) or saturated (SAFA).

The fat-based confection composition preferably comprises from 10 wt % to 35 wt % SAFA, from 15 wt % to 30 wt % SAFA, from 20 wt % to 29 wt % SAFA, or even from 21 wt % to 28 wt % SAFA.

In an embodiment of the invention the fat-based confection composition comprises from 45 wt % to 65 wt % fat and from 20 wt % to 29 wt % SAFA.

In an embodiment of the invention the fat has a solid fat content of greater than 90% at −18° C., greater than 80% at −12° C., and greater than 50% at 0° C., a solid fat content of greater than 92% at −18° C., greater than 85% at −12° C., and greater than 60% at 0° C., a solid fat content of greater than 94% at −18° C., greater than 87% at −12° C., and greater than 70% at 0° C.

Non-fat solid particles include, for example: calcium carbonate; particles originating from cocoa solids (i.e.: cocoa powder); non-fat milk solids; bulking agents, and sugars. The bulking agent may be an insoluble fibre derived from plant-based material, soluble fibres derived from starches, pectins and cellulosic materials, soluble proteins, for example, vegetable proteins and insoluble vegetable proteins and insoluble minerals, for example calcium phosphate.

Calcium carbonate means natural ground or precipitated calcium carbonate. Calcium carbonate does not mean calcium carbonate having porous particles, i.e. particles having intraparticle pores and a specific surface area of from 15 m²/g to 200 m²/g, such as surface reacted calcium carbonate disclosed in US 2020/0187538 A1. Calcium carbonate means particles having a specific surface area of from 1 m²/g to 12 m²/g, from 1.5 m²/g to 11 m²/g, from 2.0 m²/g to 10 m²/g. Methods of measurement are provided in US 2020/0187538 A1.

The calcium carbonate has a volume median particle size diameter (Dᵥ₅₀) of from 1.2 microns to 8 microns, from 1.3 microns to 6 microns, more preferably from 1.4 microns to 5 microns, more preferably from 1.4 microns to 1.6 microns.

Volume median particle size, Dᵥ₅₀ value, measured using a Malvern Mastersizer 2000 Laser Diffraction System, indicates a diameter value such that 50% by volume of the particles have a diameter of less than this value. A method of measuring Dᵥ₅₀ is described in EP 3 250 042 A1.

The fat-based confection composition comprises from 1 wt % to 40 wt % calcium carbonate, preferably from 5 wt % to 35 wt % calcium carbonate, more preferably from 10 wt % to 30 wt % calcium carbonate, more preferably from 10 wt % to 25 wt % calcium carbonate.

Particles originating from cocoa solids means any product derived from cocoa beans and includes cocoa powder. Cocoa powder is the cocoa press cake resulting from the processing of cocoa liquor obtainable from cocoa beans. Typically, cocoa powder comprises 10 wt % to 12 wt % fat and 88 wt % to 90 wt % non-fat cocoa solids (The Science of Ice Cream: C. Clarke; RSC 2012, Ch 3). Particles originating from cocoa solids is intended to include materials derived from cocoa such as cocoa fibre or cocoa shell fibre or carob.

Non-fat milks solids means milk products such as skimmed milk powder, whey powders or buttermilk powder. Non-fat milk solids and their sources are described in ‘Ice Cream’ H. Goff and R. Hartel, Springer 7^{th} Ed, 2013, pages 60-65.

Sugars includes monosaccharides, disaccharides, oligosaccharides, polysaccharides, sugar alcohols, and mixtures thereof. Monosaccharides include: glucose; fructose; galactose; and allulose. Disaccharides include: sucrose; lactose; and trehalose. Oligosaccharides have a degree of polymerization (DP) between 3 and 10, for example: low molecular weight glucans, low molecular weight dextrins, maltodextrins and fructooligosaccharides (FOS). Polysaccharides typically have a DP greater than 10, for example: starch and inulin. Sugar alcohols include maltitol, xylitol, sorbitol, erythritol and mannitol. Preferably sugars is selected from the group consisting of glucose, fructose, galactose, allulose, sucrose, lactose, trehalose, and mixtures thereof.

Sugars typically provides sweetness to a fat-based confection composition. Sugars may be added to the fat-based confection composition as a sugar ingredient or may be added as another component of a non-fat solid particle, for example, cocoa powder may comprise polysaccharides. ‘Sugars’ is intended to mean the total sugar content of the fat-based confection composition including both sugars originating from any ingredient and added sugar. The term ‘sugars’ is synonymous with ‘sugar’ and may be used interchangeably, ‘sugars’ and ‘sugar’ are intended to mean the total content of sugar in a fat-based confection composition. ‘Added sugar’ means sugars that are added to the fat-based confection composition as a sugar ingredient, e.g. sucrose.

The fat-based confection composition comprises from 5 wt % to 45 wt % sugars, for example 20 wt % to 45 wt % sugas. The fat-based confection composition preferably comprises from 10 wt % to 35 wt % sugars, from 15 wt % to 30 wt % sugars, or even from 20 wt % to 28 wt % sugars.

The emulsifier is preferably selected from the group consisting of lecithin, ammonium phosphatides, PGPR, and mixtures thereof. Lecithin may be, for example, sunflower lecithin or soybean lecithin. Preferably the emulsifier is selected from the group consisting of sunflower lecithin, soybean lecithin, and mixtures thereof.

In an embodiment of the invention the fat-based confection composition comprises from 0.05 wt % to 1.0 wt % emulsifier, from 0.1 wt % to 0.5 wt % emulsifier, from 0.15 wt % to 0.35 wt % emulsifier.

In a preferred embodiment, the fat-based confection composition comprises from 1 wt % to 40 wt % calcium carbonate and from 20 wt % to 45 wt % sugars.

In a preferred embodiment, the fat-based confection composition comprises from 1 wt % to 40 wt % calcium carbonate and from 20 wt % to 45 wt % sugars, wherein the sugar comprises fructose.

In a preferred embodiment, the fat-based confection composition of step (a) comprises from 34 wt % to 65 wt % non-fat solid particles, from 35 wt % to 65 wt % fat, and from 0.05 wt % to 1.0 wt % emulsifier.

In a preferred embodiment, the fat-based confection composition of step (a) comprises a blend of fats, wherein the blend comprises fats selected from the group consisting of cocoa butter, coconut oil, high oleic liquid oils, sunflower oil, olive oil, and mixtures thereof.

In a preferred embodiment, the fat-based confection composition comprises from 1 wt % to 40 wt % calcium carbonate, from 35 wt % to 65 wt % fat, from 20 wt % to 45 wt % sugars, from 2 wt % to 15 wt % cocoa powder and from 0.05 wt % to 1.0 wt % emulsifier, and wherein the calcium carbonate has a mean diameter particle size of from 1.2 to 8 microns.

Fat-based confection compositions may also comprise additional ingredients such as one or more colourings and/or one or more flavourings. Exemplary colourings and flavourings are described in Chapter 3 of The Science of Ice Cream: C. Clarke; RSC 2012; and Chapter 4 of ‘Ice Cream’ 7^{th} Ed., Goff and Hartel, 2013 Springer, New York.

In an embodiment of the invention, the confection product comprising a confection and a fat-based confection composition may be an ambient, chilled or frozen confection product. The resultant product is preferably a coated confection product wherein the coating comprises a fat-based confection composition and the confection is ambient, chilled or frozen.

An embodiment of the invention relates to use of the fat-based confection composition for coating a confection, preferably a frozen confection, or bakery item. The resultant product is a coated confection or bakery item wherein the coating comprises a fat-based confection composition.

The invention also relates to use of the fat-based confection composition for coating a frozen confection or bakery item. A coated bakery item may be, for example: a biscuit; wafer cone or waffle cone, coated with the fat-based frozen confection composition, typically the coating is located on the internal surface of the cone. The coated bakery item may additionally comprise frozen confection (added after the coating has been applied) to form a frozen confection cone product. The fat-based confection composition may be present as a partial or full coating of a frozen confection to form a partially or fully coated frozen confection product. Alternatively, the fat-based confection composition may be present as a topping. Alternatively, the fat-based confection composition may be applied to a receptacle to coat the inside of the receptacle prior to addition of frozen confection, as described in WO 2017/001372 A1. Exemplary coated frozen confection products and apparatus and methods for coating are described in Chapter 5 of The Science of Ice Cream by Chris Clarke (2012, ISBN: 0-85404-629-1) and Chapter 9 of Ice Cream by H. Douglas Goff and Richard W. Hartel (2013, 7^{th} Edition, ISBN: 978-1-4614-6096-1).

A fat-based confection composition for use as a coating for a frozen confection or frozen confection bakery item may also be known as a fat-based frozen confection coating composition or frozen confection coating composition.

Fat-based frozen confection coating composition means a composition that, when in liquid form and applied to the surface of a frozen confection or bakery item, solidifies on or shortly after contact with the frozen confection or bakery item. Frozen confection coating composition means a fat-based edible material for use to form a coating layer on the surface of a frozen confection or bakery item.

A coated frozen confection product may be made by a process comprising the steps of:
(i) heating the fat-based confection composition to a temperature of from 35° C. to 55° C.;
(ii) dipping a frozen confection into the heated fat-based confection composition of step (i);
(iii) cooling the coated frozen confection product of step (ii).

The process may also comprise step(iv):
(iv) optionally hardening the cooled product of step (iii).

An item may be coated by the frozen confection coating composition by spraying. For example by a process for the preparation of a coated frozen confection product comprising the steps of:
(i) heating the fat-based confection composition to a temperature of from 35° C. to 55° C.;
(ii) spraying the heated fat-based confection composition of step (i) onto an item;
(iii) cooling the coated item of step (ii).

The process may also comprise step (iv):
(iv) optionally hardening the cooled of step (iii).

The invention relates to the use of a fat-based confection composition for coating a frozen confection or bakery item.

In a further embodiment, the invention relates to the use of a fat-based confection composition for coating a frozen confection to obtain a coated frozen confection product, wherein the coating is applied by dipping, i.e. the frozen confection is dipped into a vessel comprising a fat-based confection composition.

In a further embodiment, the invention relates to the use of a fat-based confection composition for coating a frozen confection to obtain a coated frozen confection product, wherein the coating is applied by spraying.

Processes for dipping, spraying and coating are described in for example US 2017/0318831 A1 and WO 2017/001372 A1.

In a further embodiment of the invention, the invention relates to a coated frozen confection product comprising a fat-based confection composition, wherein the thickness of the coating of the coated frozen confection product varies by from 0% to 30%, from 0% to 20%, from 0% to 15%, from 0% to 13%.

In a further embodiment, the invention relates to a frozen confection product comprising a frozen confection and a fat-based confection composition, wherein the fat-based confection composition may be a sauce, inclusion, coating or topping.

In a further embodiment, the invention relates to a frozen confection product comprising a bakery item and a fat-based confection composition.

In a further embodiment, the invention relates to a confection product comprising a bakery item and a fat-based confection composition.

### FIGURES

FIG. 1: Confocal image of the fat-based confection composition of sample 10.

FIG. 2: Confocal image of the fat-based confection composition of sample 9.

FIG. 3: Confocal image of the fat-based confection composition of sample 6 (40 wt % calcium carbonate).

FIG. 4: Confocal image of the fat-based confection composition of sample 3 (7.5 wt % calcium carbonate).

FIGS. 5a to 5d: photographs of samples 11, 14, 15, and 16 after 24 h of storage.

### EXAMPLES

### General Method 1: Preparation of the Fat-Based Confection Composition

Sugar and calcium carbonate were added to a pre-heated mill grinding chamber [ball mill, 50° C.] and mixed and kneaded. The remaining non-fat solids were added, and the mixture was kneaded and refined until the Dᵥ₅₀ of the particles of the mixture was less than 30 microns, measured using a Draper external digital micrometer. Fat and optional emulsifier were heated to greater than 40° C. and added to the refined non-fat solids mixture to form a dispersion. The resultant fat-based confection composition was removed from the mill, cooled to −25° C. and stored.

### General Method 2: Experimental Method for Measuring the Rheology of the Frozen Confection Coating Composition

Chocolate and oil rheology measurements were made on a Physica MCR501 at 40° C. using a 17 mm profiled cup and bob (cc17-0-25/p6 and c-cc17/T200/SS/P).

### The Method was a Step Method:

Step 1 is a pre-shear to condition the material at a shear rate of 5 1/s
Step 2 is shear rate ramp from 2 to 50 1/s over 3 mins
Step 3 constant shear rate at 50 1/s for 1 min
Step 4 is shear rate ramp from 50 to 2 1/s over 3 mins

Only step 4 is analysed to extract the Casson parameters. Data analysed is from 50 1/s to 5 1/s. Square root of stress is plotted on the y-axis and square root of shear rate is plotted on the x-axis. The square of the slope gives the Casson viscosity and the square of the intercept gives the Casson yield.

### General Method 3:

Samples were imaged on the Zeiss LSM 780 confocal microscope in channel mode. A range of objective lenses 10×, 20×, 40×, and 63× with numerical apertures of 0.45, 0.80, 1.3 and 1.4 respectively. The image resolution was set to 1024×1024 pixels. Multitrack sequential acquisition settings were used to avoid inter-channel cross-talk. The confocal pinhole was set to 1 Airy unit. The image collection was carried out in sequential line mode with 4× averaging, 1× zoom and a 1.58 μs pixel dwell time.

Unstained samples of chocolate diluted in mineral oil were imaged without any further treatment using three broad fluorescence channels to capture any auto-fluorescence. Excitation was via a 405 nm diode laser (with a linked polarised transmitted light channel), 488 nm line of an argon ion laser and 561 nm diode solid state laser. The emission detection bandwidths were 428 to 474 nm, 517 to 580 nm and 649 to 759 nm.

### General Method 4: Preparation of the Coated Frozen Confection Product

Fat-based confection composition was prepared according to General Method 1 and heated to 40° C. A frozen confection stick product was prepared, exemplary frozen confections are described in The Science of Ice Cream: C. Clarke; RSC 2012. The frozen confection was held by the stick and dipped into the fat-based confection composition. The fat-based frozen confection composition was allowed to solidify and form a coated frozen confection product.

### Example 1

Frozen confection coating compositions having the composition according to Table 1 were prepared according to General Method 1. For samples 1, 2, 8 and 10 this method was followed without the addition of calcium carbonate.

TABLE 1
Fat-based confection compositions

| | Sample | | | | |
|---|---|---|---|---|---|
| Ingredient (wt %) | 1 | 2 | 3 | 4 | 5 |
| Non-fat solids comprising sugar | 47.7 | 47.7 | 40.2 | 35.2 | 22.7 |
| (excl. CaCO₃) | | | | | |
| CaCO₃ [Dᵥ₅₀ = 1.5 micron] | 0 | 0 | 7.5 | 12.5 | 25 |
| Emulsifier | 0.3 | 0.3 | 0.3 | 0.3 | 0.3 |
| Fat | 52 | 52 | 52 | 52 | 52 |
| | Sample | | | | |
| Ingredient (wt %) | 6 | 7 | 8 | 9 | 10 |
| Non-fat solids comprising sugar | 7.7 | 28.2 | 47.7 | 28.2 | 47.7 |
| (excl. CaCO₃) | | | | | |
| CaCO₃ [Dᵥ₅₀ = 1.5 micron] | 40 | 18.5 | 0 | 18.5 | 0 |
| Emulsifier | 0.3 | 0.3 | 0.3 | 0.3 | 0.3 |
| Fat | 52 | 53 | 52 | 53 | 52 |

Water (0.5 wt %) was added to the fat-based confection compositions of samples 2 to 6, 9 and 10, and the Casson viscosity and Casson yield were measured according to General Method 2. The results are summarised in Table 2.

TABLE 2
Casson viscosity and Casson yield

| | | CaCO₃ | Water | Casson Viscosity | Casson Yield |
|---|---|---|---|---|---|
| Sample | Sugar | (wt %) | (wt %) | (Pa · s) | (Pa) |
| 1 | Sucrose | 0 | 0 | 0.19 | 0.11 |
| 2 | Sucrose | 0 | 0.5 | 0.12 | 10.33 |
| 3 | Sucrose | 7.5 | 0.5 | 0.09 | 11.53 |
| 4 | Sucrose | 12.5 | 0.5 | 0.03 | 11.53 |
| 5 | Sucrose | 25 | 0.5 | 0.05 | 5.26 |
| 6 | Sucrose | 40 | 0.5 | 0.06 | 2.31 |
| 7 | Fructose | 18.5 | 0 | 0.10 | 1.00 |
| 8 | Fructose | 0 | 0 | 0.17 | 0.51 |
| 9 | Fructose | 18.5 | 0.5 | 0.36 | 6.98 |
| 10 | Fructose | 0 | 0.5 | 0.32 | 12.9 |

Coated frozen confection products were prepared according to General Method 4.

The coated frozen confection products prepared using the composition of sample 5 comprised 32% less coating per product that frozen confection products prepared using the composition of sample 2. The reduced coating per product is a consequence of 25 wt % calcium carbonate present in the fat-based confection composition of sample 5 compared to sample 2 reflected by the reduction in Casson viscosity (0.05 Pa·s of sample 5 compared to 0.12 Pa·s of sample 2) and Casson yield (5.26 Pa of sample 5 compared to 10.33 Pa of sample 2).

The coated frozen confection products prepared using the composition of sample 9 comprised 20% less coating per product that frozen confection products prepared using the composition of sample 10. The reduced coating per product is a consequence of 18.5 wt % calcium carbonate present in the fat-based confection composition of sample 9 compared to sample 10 and is reflected in the reduction in Casson viscosity (0.36 Pa·s of sample 9 compared to 0.32 Pa·s of sample 10) and Casson yield (6.98 Pa of sample 9 compared to 12.9 Pa of sample 10) of the fat-based confection compositions.

Samples 1 to 10 demonstrate that the rheology of the fat-based confection compositions that comprise calcium carbonate and sugar is less affected by the presence of water than fat-based confection compositions that do not comprise calcium carbonate. Furthermore, samples 1 to 10 demonstrate that fat-based confection composition comprising 0.5 wt % water are suitable for use as frozen confection coating compositions and are suitable for use in methods for dipping, spraying and enrobing frozen confection.

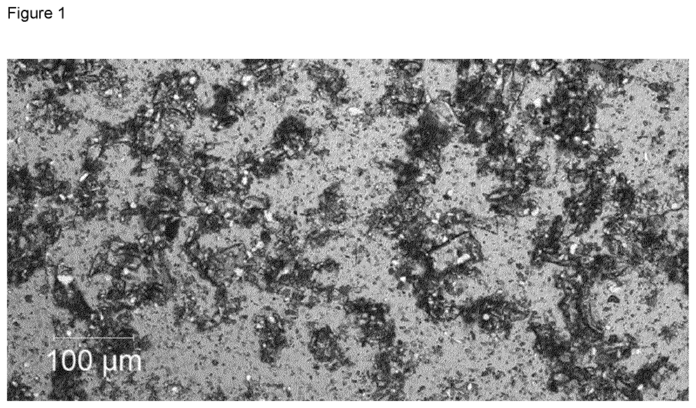

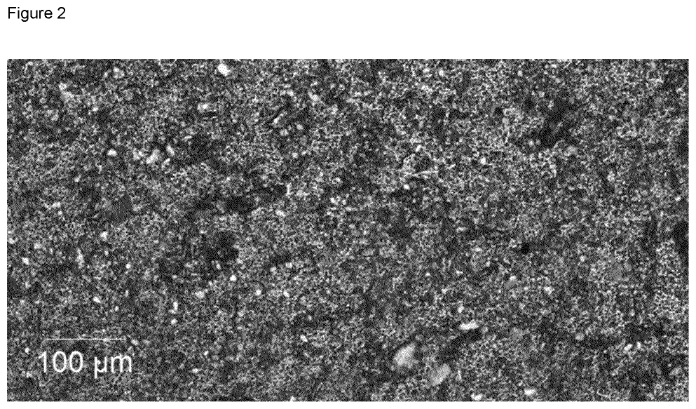

FIG. 1 is a confocal image of the fat-based confection composition of sample 10. FIG. 1 demonstrates that water typically interacts with the sugar of the fat-based confection compositions that do not comprise calcium carbonate, resulting in aggregation of the particles of the fat-based confection composition. It is postulated that the particles become sticky and prevent solidification of the fat-based confection composition. As demonstrated by Examples 2 and 10, sticky sugar particles increase both the Casson Viscosity and Casson Yield of the fat-based confection composition. FIG. 2 is a confocal image of the fat-based confection composition of sample 9. In contrast, FIG. 2 demonstrates that fat-based confection compositions comprising calcium carbonate and sugar, are less susceptible to aggregation. Consequently, fat-based confection compositions comprising calcium carbonate and sugar have a greater resilience to the increase in Casson viscosity and Casson yield caused by the presence of water in the composition compared to fat-based confection compositions that do not comprise calcium carbonate.

It is postulated that the addition of calcium carbonate to step (a) of the process for the preparation of the fat-based confection composition results in a composition that is more resilient to the effect of the presence of water on the rheology of the composition. It is postulated that this reduction in the effect of the presence of water on the rheology of the composition may be due to a reduction in the interaction between the sugar and water present in the composition. Such an increased resilience enables fat-based compositions to tolerate a greater amount of water in, for example, processes that require the composition to come into contact with a source of water, such as coating a confection by dipping, or non-anhydrous process conditions. The increased resilience of the fat-based confection composition to water results in fat-based confection compositions having a longer shelf-life and consequently reducing waste.

Furthermore, samples 7 to 10, illustrate that fat-based confection compositions comprising calcium carbonate and sugar can comprise sugars that are more hygroscopic than sucrose, such as fructose, without significantly affecting the physical characteristics of the composition (rheology). As fructose has a greater sweetness perception than, for example sucrose, fat-based confection compositions of samples 7 and 9 comprise less sugars than the fat-based confection composition of sample 6, but would have a similar level of sweetness. samples 7 to 10 (fat-based confection compositions comprising fructose) are fat-based confection compositions comprising less sugar compared to compositions comprising sucrose with a similar sweetness perception. Consequently, samples 7 and 9 provide fat-based confection compositions comprising a reduction in calories compared to compositions comprising sucrose without affecting the physical characteristics of the composition.

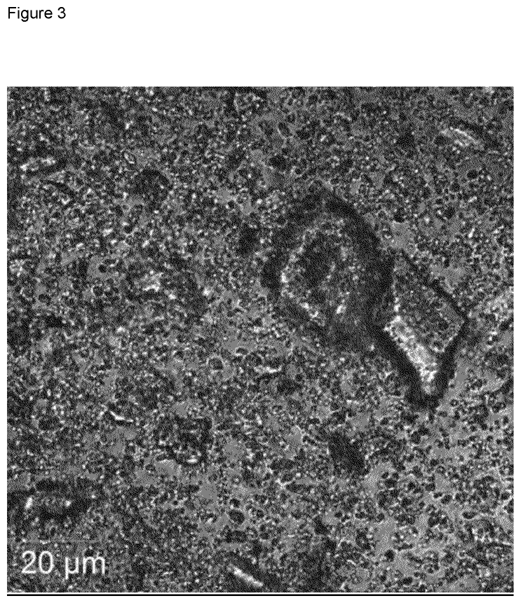

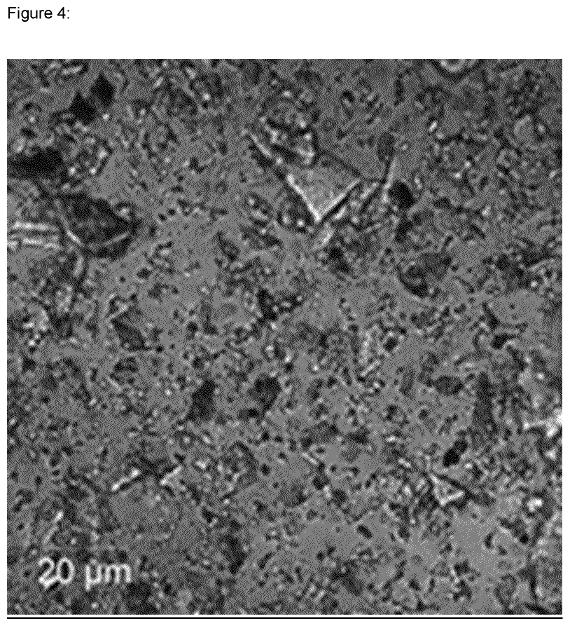

FIG. 3 is a confocal image of the fat-based composition of sample 6. FIG. 4 is a confocal image of the fat-based composition of sample 3. FIGS. 3 and 4 illustrate that calcium carbonate present in the fat-based confection composition can be seen both throughout the composition and adjacent to the sugar crystals of the composition.

### Example 2

Frozen confection coating compositions comprising fructose were prepared according to General Method 1 (samples 14, 15, and 16). For samples 11 and 13 and this method was followed without the addition of calcium carbonate. Calcium carbonate (10 wt %) was added to the coating composition of sample 13 as part of the remaining non-fat solids.

The Dᵥ₉₀ of the particles of the mixture was measured using a Draper external digital micrometer both immediately after the compositions had been made, and then after storage of the compositions for 24 hours. Casson viscosity and Casson yield were measured according to General Method 2. The results are shown in Table 3.

TABLE 3
Particle size and rheology of compositions comprising fructose

| | CaCO₃ | Storage | Dᵥ₉₀ | Casson | Casson yield |
|---|---|---|---|---|---|
| Sample | (wt %) | time | (microns) | viscosity (Pa · s) | (Pa) |
| 11 | 0 | 0 h | 24.7 | 0.16 | 0.95 |
| | | 24 h | 57.7 | 0.27 | 1589 |
| 13 | 10 | 0 h | 37.7 | — | — |
| 14 | 10 | 0 h | 27.1 | 0.13 | 1.25 |
| | | 24 h | 28.2 | 0.13 | 1.05 |
| 15 | 20 | 0 h | 24.5 | 0.10 | 1.06 |
| | | 24 h | 24.4 | 0.10 | 0.97 |
| 16 | 30 | 0 h | 18.9 | 0.08 | 1.36 |
| | | 24 h | 18.6 | 0.08 | 1.32 |

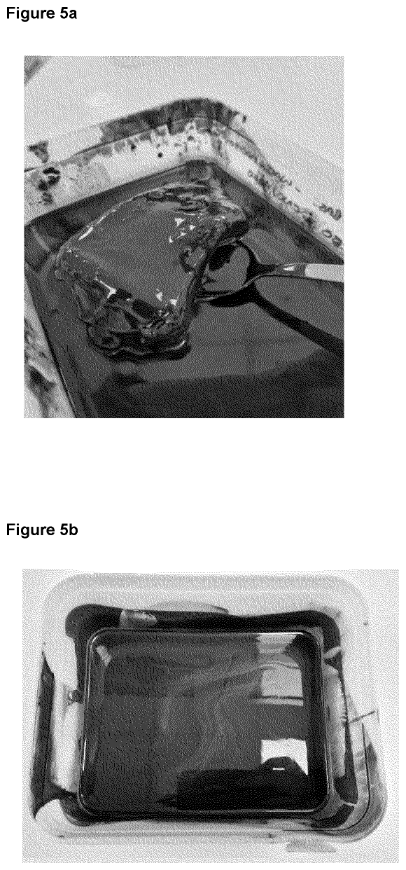

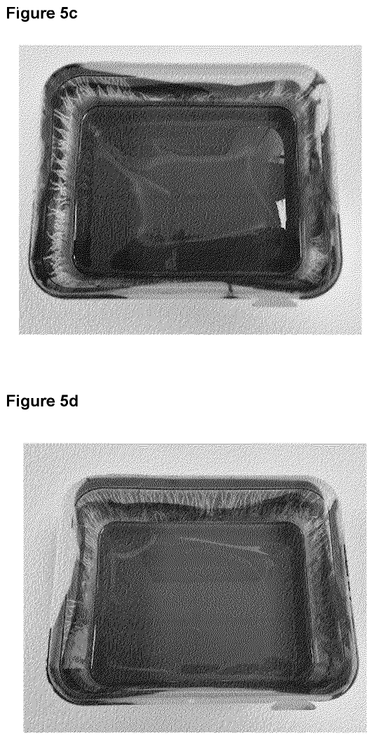

Sample 11 shows that it is possible to refine a coating composition comprising fructose to achieve a suitable Dᵥ₉₀ particle size. However, the high hygroscopicity of the fructose means that this composition is already unsuitable for use as a coating after a mere 24 hours of storage. Indeed, as can be seen from FIG. 5a, the composition has already undergone significant aggregation after 24 hours of storage. In contrast, for the samples comprising both fructose and calcium carbonate and prepared according to the method of the present invention (samples 14, 15, and 16), the Dᵥ₉₀ particle size remained stable even after 24 hours of storage. As can be seen from FIGS. 5b to 5d, the compositions remain smooth and flowable even after 24 hours of storage.

Sample 13 shows that the calcium carbonate needs to be added in step (a) of the process in order to achieve a suitable Dᵥ₉₀ particle size. Subsequent addition of Calcium carbonate results in a higher Dᵥ₉₀ particle size than even sample 11 (storage time=0 h).

1. A process for the preparation of a fat-based confection composition comprising the steps of:
(a) mixing and heating a composition comprising: non-fat solid particles, fat and emulsifier to form a dispersion, wherein the non-fat solid particles comprise sugars and calcium carbonate, wherein the calcium carbonate has a volume median particle size diameter (Dᵥ₅₀) of from 1.2 microns to 8 microns and does not comprise surface reacted calcium carbonate having a specific surface area of from 15 m²/g to 200 m²/g;
(b) optionally admixing additional non-fat solid particles;
(c) optionally kneading the composition of step (a) or (b);
(d) refining the particles of the dispersion of steps (a), (b), or (c) wherein the particles of the dispersion have a Dᵥ₉₀ of less than 50 microns;
(e) optionally admixing additional fat and emulsifier to the dispersion of step (d);
(f) optionally conching the dispersion of steps (d) or (e);
(g) optionally fluidizing the product of step (d), (e), or (f); and
(h) optionally cooling to less than 10° C.

2. A process for the preparation of a fat-based confection composition as claimed in claim 1, wherein the composition of step (a) is heated to greater than 40° C.

3. A process for the preparation of a fat-based confection composition as claimed in claim 1, wherein the dispersion of step (f) is heated to from 45° C. to 90° C.

4. A process for the preparation of a fat-based confection composition as claimed in claim 1, wherein the calcium carbonate has a volume median particle size diameter (Dᵥ₅₀) of from 1.3 microns to 6 microns.

5. A process for the preparation of a fat-based confection composition as claimed claim 1, wherein the non-fat solid particles comprise sugars selected from the group consisting of glucose, fructose, galactose, allulose, sucrose, lactose, trehalose, and mixtures thereof.

6. A process for the preparation of a fat-based confection composition as claimed in claim 1, wherein the composition of step (a) comprises from 1 wt % to 40 wt % calcium carbonate and from 20 wt % to 45 wt % sugars.

7. A process for the preparation of a fat-based confection composition as claimed in claim 1, wherein the composition of step (a) comprises from 34 wt % to 65 wt % non-fat solid particles, from 5 wt % to 65 wt % fat and from 0.05 wt % to 1.0 wt % emulsifier.

8. A process for the preparation of a fat-based confection composition as claimed in claim 1, wherein the composition of step (a) comprises non-fat solid particles selected from the group consisting of sugars, calcium carbonate, cocoa powder and non-fat milk solids, and mixtures thereof.

9. A process for the preparation of a fat-based confection composition as claimed in claim 1, wherein the fat is selected from the group consisting of palm stearin, palm kernel oil, cocoa butter, cocoa butter replacer, cocoa butter equivalent, coconut oil, high oleic liquid oils, sunflower oil, safflower, canola oil, corn oil, olive oil, cottonseed oil, flax seed oil, almond oil, soybean oil, grapeseed oil, rice bran oil, hemp seed oil, sesame oil, peanut oil, butter oil, and mixtures thereof.

10. A process for the preparation of a fat-based confection composition according to claim 1, wherein the fat-based confection composition comprises from 1 wt % to 40 wt % calcium carbonate, from 35 wt % to 65 wt % fat, from 20 wt % to 45 wt % sugar, from 2 wt % to 15 wt % cocoa powder and from 0.05 wt % to 1.0 wt % emulsifier.

11. A fat-based confection composition obtainable by the process according to claim 1, wherein the fat-based confection composition comprises from 1 wt % to 40 wt % calcium carbonate and from 20 wt % to 45 wt % sugars, wherein the calcium carbonate has a volume median particle size diameter (Dᵥ₅₀) of from 1.2 microns to 8 microns and does not comprise surface reacted calcium carbonate having a specific surface area of from 15 m²/g to 200 m²/g, wherein the sugars comprises fructose, and wherein the particles of the composition have a Dᵥ₉₀ of less than 50 microns, and wherein step (a) of the process comprises mixing and heating a composition comprising: non-fat solid particles, fat and emulsifier to form a dispersion, wherein the non-fat solid particles comprise fructose and calcium carbonate.

12. A confection product comprising a confection and a fat-based confection composition of claim 11, wherein the confection product is ambient, chilled or frozen.

13. Use of a fat-based confection composition according to claim 11 for coating a frozen confection or bakery item.

14. A coated confection product wherein the coating comprises a fat-based confection composition according to claim 11 and the confection product is ambient, chilled or frozen.

15. A confection product comprising a coated bakery item wherein the coating comprises a fat-based confection composition according to claim 11.
